(19) United States
(12) Patent Application Publication
(10) Pub. No.: US 2005/0121930 A1
(43) Pub. Date: Jun. 9, 2005

(54) Method of precisely joining an accessory such as a running board to an attachment bracket and/or vehicle

(76) Inventors: Samson Ling, Huntsville (CA); Nathan Keith, Huntsville (CA)

Correspondence Address: HARNESS, DICKEY & PIERCE, P.L.C., P.O. BOX 828, BLOOMFIELD HILLS, MI, 48303, US

(21) Appl. No.: 10/726,819

(22) Filed: Dec. 3, 2003

(51) Int. Cl. B62D 27/00

(52) U.S. Cl. 296/29

(57) ABSTRACT

A method of attaching a vehicle accessory, such as a running board, to an attachment bracket and/or a vehicle, wherein the attachment method requires no additional discrete fasteners. Furthermore, the positioning of the accessory relative to the vehicle or bracket is precisely controlled by means of datum references, set on the accessory, vehicle, and or bracket.

### FIELD OF THE INVENTION

The present invention relates to the method of attaching a vehicle accessory such as a running board, to an attachment bracket and/or a vehicle. Specifically, requiring no additional fasteners and precisely positioning the accessory in reference to a datum on the accessory bracket and/or vehicle.

### BACKGROUND OF THE INVENTION

The accurate locating of a vehicle accessory to a vehicle is often made difficult because of vehicle and part variation. Presently known accessories are joined to a vehicle by discrete fasteners that screw through holes or slots in the joining surface that are larger than the fastener itself. Thus a degree of positional adjustment can be made between the accessory, its mounting bracket system and/or the vehicle prior to tightening the fasteners.

Also, presently known in the art are accessories that are mounted to their respective bracket system and/or vehicle by snap-together means. Here also, however, due to the mean of manufacturing such components, snap-together joints have limited adjustability to accommodate for accessory, bracket or vehicle variation and/or adjustment during attachment.

It is therefore advantageous to have vehicular accessories that can be manufactured and assembled quickly, easily and without the need for discrete fasteners or hardware, thereby driving down production costs and installation time, while still maintaining a secure and strong assembly with a precise fit and finish.

### SUMMARY OF THE INVENTION

It is therefore an object of the present invention to provide a method of installing an accessory to a vehicle in a precise manner without the use of discrete fasteners and without the need for adjustability.

It is another object of the present invention to provide a method of installing an accessory to a vehicle in a precise manner that can compensate for individual vehicle and part variations.

A further object of the present invention is to provide for a method of aligning an accessory with a vehicle or mounting bracket prior to assembly which provides for a precise and accurate attachment thereof.

These and other objects are achieved in a vehicle accessory mounting method disclosed in the following embodiments which comprises both a secure, fastenerless joining method and a precise locating method, providing for cost-effective, simple attachment.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a partial cross-sectional view of first embodiment of an accessory joining zone prior to joining with the vehicle or bracket;

FIG. 2 is a cross sectional view of the accessory joining zone of FIG. 1 after the joint has been secured, wherein the accessory's protrusion has been formed so as to lock the accessory to the bracket or vehicle;

FIG. 3 is a partial cross-sectional view of a second embodiment of an accessory joining zone prior to joining with the vehicle or bracket;

FIG. 4 is a cross-sectional view of the accessory joining zone of FIG. 3 showing the joint after being secured, wherein the ferrous media has been induction heated;

FIG. 5 is a partial cross-sectional view of a third embodiment of an accessory joining zone prior to joining with the vehicle or bracket;

FIG. 6 is a cross-sectional view of the accessory joining zone illustrated in FIG. 5, after the joint has been secured, wherein an adhesive or solvent has bonded the parts together;

FIG. 7 is a partial cross-sectional view of a fourth embodiment of an accessory joining zone prior to joining with the vehicle or bracket;

FIG. 8 is a cross-sectional view of the accessory joining zone illustrated in FIG. 7, after the joint has been secured, wherein an adhesive tape has bonded the parts together;

FIG. 9 is a partial cross-sectional view of a fifth embodiment of an accessory joining zone prior to joining with the vehicle or bracket;

FIG. 10 is a cross-sectional view of the accessory joining zone illustrated in FIG. 9 after the joint has been secured;

FIG. 11 is a partial perspective view of a sixth embodiment of an accessory joining zone prior to joining with the vehicle or bracket; and

FIG. 12 is a partial cross-sectional view of the accessory joining zone illustrated in FIG. 11 after the joint has been secured.

### DETAILED DESCRIPTION OF THE PREFERRED EMBODIMENTS

The following description of the preferred embodiments is merely exemplary in nature and is in no way intended to limit the invention, its application, or uses.

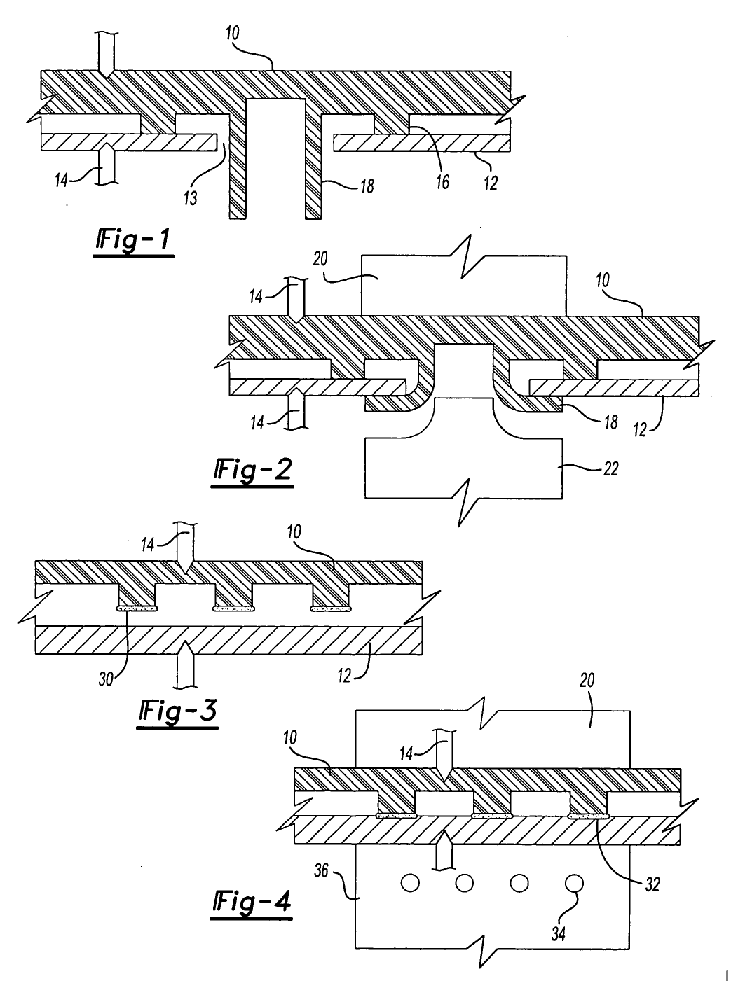

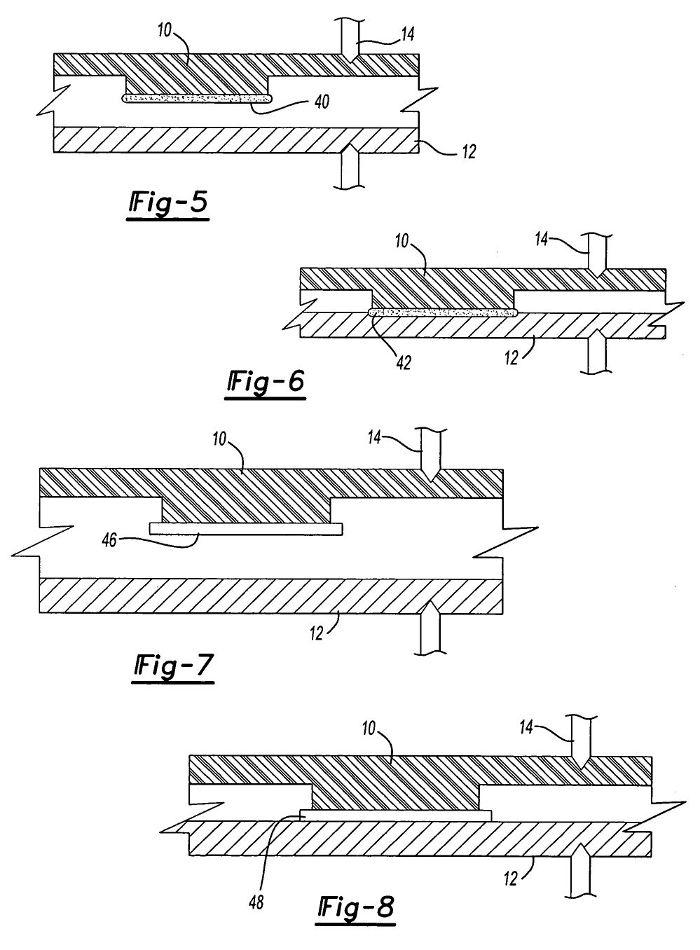

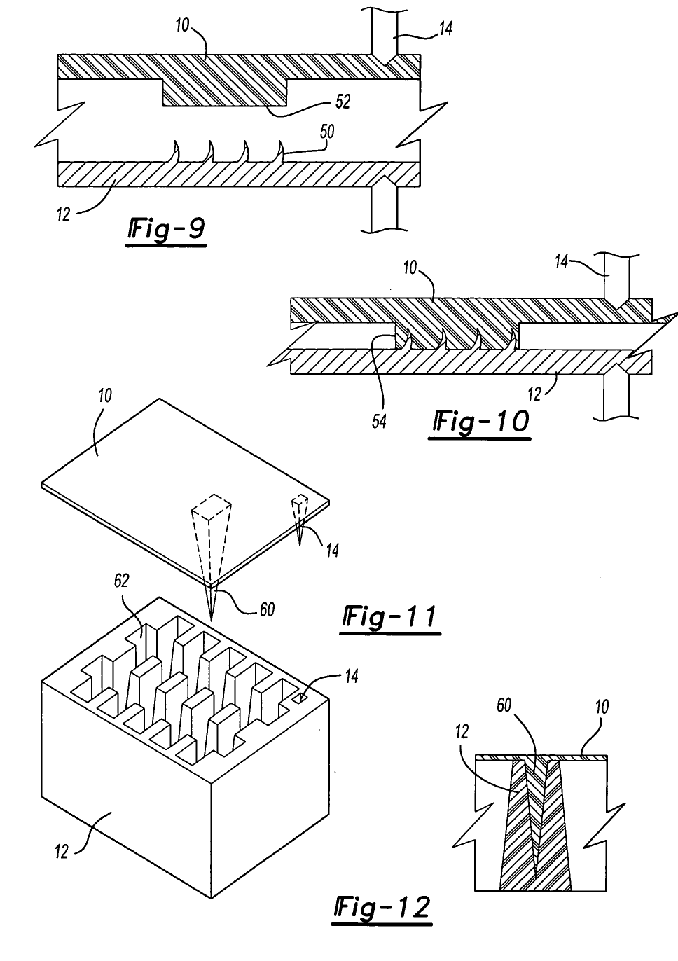

Referring to FIG. 1, a first embodiment of the present invention is shown, illustrating a vehicle accessory 10 such as a running board, positioned for attachment to a vehicle or bracket member 12. The accessory 10 has a generally planar area proximal the joining zone, and comprises one or more spacers 16 molded therein for positioning the bracket off the vehicle/bracket 12 surface. Datum locators 14 are utilized on both the vehicle/bracket 12 and the accessory 10, to allow precise positioning of the two components prior to joining.

To join the accessory 10 to the vehicle/bracket 12 as shown in FIG. 2, the accessory is positioned via the datum locators 14, so as to align the pre-formed protrusions 18 on the accessory 10 through a corresponding receiving aperture 13 located on the vehicle/bracket. A support means 20 holds the accessory 10 in position while applying an opposing forming tool 22, to the protrusions 18 creating a locking flare on the bottom side of the vehicle/bracket 12, securing the accessory 10 in position. The forming operation can use heat and/or force to plastically deform the protrusion 18 about the vehicle/bracket 12. During the forming process the relative location of the accessory 10, or vehicle/bracket 12 is defined by one or more datum locations 14 and fixtured thus to prevent any post-joining movement. Any of six degrees of freedom can be located and locked into place by this method.

In a second embodiment, illustrated in FIG. 3, a plastic accessory 10 is joined to the vehicle/bracket 12 by means of a weld. A ferrous media 30 is applied to mounting locations on the accessory 10. The accessory 10 is then positioned proximal its mounting location, utilizing the datum locators 14 and the support tools 20 and 36. Once the accessory 10 is abutted to the vehicle/bracket 12, a series of induction heating coils 34 secures the accessory 12 by supplying sufficient induction heat to the ferrous media, which locally melts the accessory 10 and vehicle/bracket 12 after which they are pressed and welded together as illustrated in FIG. 4. During the pressing and welding process the relative location of the accessory 10, or vehicle/bracket 12 is defined by one or more datum locations and fixtured thus to prevent any post-joining movement. Any of six degrees of freedom can be located and locked into place by this method.

Referring now to FIGS. 5 and 6 illustrating a further embodiment, an accessory 10 is joined to the vehicle/bracket 12 by means of an applied adhesive or solvent 40 in between the accessory 10 and the vehicle/bracket 12. Prior to joining, the adhesive or solvent 40 is applied to mounting locations on the accessory 10, at which time the accessory 10 is subsequently pressed and bonded to the vehicle/bracket 12. During the pressing and bonding process the relative location of the accessory 10 and vehicle/bracket 12 is defined by one or more datum locations 14 and fixtures thus to prevent any post-curing movement. Any of six degrees of freedom can be located and locked into place by this method.

FIGS. 7 and 8 illustrate a further embodiment, wherein an accessory 10 is joined to the vehicle/bracket 12 by means of an applied adhesive tape 46 in between the accessory 10 and the vehicle/bracket 12. Prior to joining, the adhesive tape 46 is applied to mounting locations on the accessory 10, at which time the accessory 10 is subsequently pressed and bonded to the vehicle/bracket 12. During the pressing and bonding process the relative location of the accessory 10 and vehicle/bracket 12 is defined by one or more datum locations 14 and fixtures thus to prevent any post-curing movement. Any of six degrees of freedom can be located and locked into place by this method as well.

FIG. 9 illustrates a further embodiment, wherein an accessory 10 is joined to the vehicle/bracket 12 by means of a series of barbs 50 or suchlike sharp protrusions that are strong enough to penetrate the communicating joint area 52 located on the surface of the vehicle/bracket 12, or in the alternative on the accessory 10 itself, when applied by force.

Referring now to FIG. 10, showing the accessory joining zone of FIG. 9 after the joint has been secured, wherein the sharp protrusions 50 have penetrated the communicating part 52 and by friction or barb orientation within the communicating part have joined the parts together. During the mechanical joining process the relative location of the accessory 10, vehicle/bracket 12 is defined by one or more datum locations 14 and fixtures thus to prevent any post-joining movement. Any of six degrees of freedom can be located and locked into place by this method.

FIGS. 11 and 12 illustrate another alternative embodiment to the present invention, illustrating a partial perspective view of an accessory joining zone prior to joining wherein the accessory 10, or vehicle/bracket 12 has at least one area with one or more tapered protrusions 60, sized such that an interference fit can be obtained with the communicating joint area receptacles 62. The communicating joint area receptacles 62 are sized such that any one of the receptacles may be used as a joint location.

After the tapered protrusions 60 have penetrated the communicating part 62 the friction between the communicating parts forms the mechanism by which the parts are joined together. During the mechanical joining process the relative location of the accessory 10 or vehicle/bracket 12 is defined by one or more datum locations 14 and fixtures thus to prevent any post-joining movement. Any of six degrees of freedom can be located and locked into place by this method.

The description of the invention is merely exemplary in nature and, thus, variations that do not depart from the gist of the invention are intended to be within the scope of the invention. Such variations are not to be regarded as a departure from the spirit and scope of the invention.

1. A vehicle accessory mounting assembly comprising:
a vehicle accessory, said accessory having at least one bracket joining zone;
a mounting bracket having at least one accessory joining zone, and at least one vehicle attachment zone;
a vehicle, said vehicle having at least one corresponding accessory joining zone;
a first means of joining the bracket joining zone to the accessory joining zone, wherein the first means of joining comprises at least one means from the group consisting of forming, welding, bonding, taping, mechanical joining, or taper locking;
a second means of joining the vehicle attachment zone to a vehicle, wherein the second means of joining comprises at least one means from the group consisting of forming, welding, bonding, taping, mechanical joining, or taper locking;
a means of joining said bracket joining zone to said mounting bracket joining zone precisely utilizing datum locators;
a means of joining the vehicle attachment zone to a vehicle precisely utilizing datum locators.

2. A vehicle accessory mounting assembly comprising:
a vehicle accessory, said accessory having at least one vehicle joining zone;
a vehicle, said vehicle having at least one corresponding accessory joining zone;
a means of joining the vehicle joining zone to the accessory joining zone, wherein said means of joining comprises at least one means from the group consisting of forming, welding, bonding, taping, mechanical joining, or taper locking;
a means of joining the vehicle joining zone to the accessory joining zone, precisely utilizing datum locators.
